(19) United States
(12) Patent Application Publication
(10) Pub. No.: US 2026/0249952 A1
(43) Pub. Date: Aug. 27, 2026

(54) WHEELED SNOW VEHICLE SKI AND ASSEMBLY

(71) Applicant: Scott Forrer, Durango, CO (US)

(72) Inventor: Scott Forrer, Durango, CO (US)

(21) Appl. No.: 19/648,551

(22) Filed: Apr. 15, 2026

Related U.S. Application Data
(63) Continuation of application No. 18/077,411, filed on Dec. 8, 2022.
(60) Provisional application No. 63/351,004, filed on Jun. 10, 2022.

(51) Int. Cl. B62M 27/02

(52) U.S. Cl. CPC B62M 27/02; B62M 2027/025

(57) ABSTRACT

An improved snow vehicle ski wherein a rear wheel is disposed relatively close to a spindle pivot point, allowing the snow ski to rotate around the spindle pivot point with less steering effort and still providing for proper weight distribution and ski balance. A front wheel is disposed forwardly of the rear wheel and the spindle pivot point. Placement of the front wheel is important as the front wheel encounters obstacles first and needs to protect the rest of the ski and its associated suspension assembly parts by absorbing impact and shock to such parts. The front wheel location is also important for proper weight distribution, handling and steering of the machine. The front wheel also acts as a lever, as it helps turn the snow ski around the spindle pivot point, providing for less steering effort by the user. Further, the wheels can have a rubber surface or a hard and sharp surface. The wheels can also combine a hard inner core surrounded by a deformable and shock-absorbing rubber surface. The snow vehicle ski can be used with a snow vehicle assembly having one or two skis.

This Application is a continuation of U.S. Non-Provisional Patent Application No. Ser. No. 18/077,411, filed Dec. 8, 2022.

### FIELD OF THE INVENTION

The present invention relates generally to recreational vehicles commonly known as “snowmobiles” and “snow bikes” (collectively, “snow vehicles”). Snowmobiles have a body, a track disposed to the rear of the body and a pair of snow skis disposed to the front. Snow bikes likewise have a body, a track disposed to the rear of the body and a single ski disposed to the front. Snow bikes are akin to a motorcycle platform adapted for use on snow. The tracks of such snow vehicles are designed with rutted treads for digging into snow and pushing the snow vehicle through the snow. The snow skis are intended for use on snow and the ski itself is large enough to “float” on top of the snow. The skis use an upwardly curved leading portion that is designed to guide the snow vehicle along the snow, primarily gliding on or just before the surface of the snow and providing the means for steering either type of snow vehicle. During use, the snow skis may be required to traverse ice and other hard surfaces such as asphalt and the like and quite frequently encounter rocks or boulders hidden beneath the snow. More specifically, the present invention relates to an improved snow ski that allows the ski to pass over hard surfaces without damaging the bottom surface of the skis or the front suspension assembly associated with the skis.

### BACKGROUND OF THE INVENTION

Snowmobiles are snow vehicles that are well known in the art. Snow bikes are likewise well known in the art and are akin to a motorcycle that is essentially adapted for use in the snow. Though used primarily for recreation, snow vehicles provide a unique means of transportation-providing access to areas where other vehicles cannot venture. During such use, a snow vehicle may be required to traverse surfaces other than deep, powdery snow, such as asphalt roads, and often encounter random rocks, boulders and the like that lay unseen beneath the snow. Such surfaces can damage the underside of the snow vehicle skis and the front suspension assembly. Damage to the elements of the front suspension assembly can include bending of the elements and even the tearing of such elements from the snow vehicle.

Accordingly, there is a need for an improved snow vehicle ski whereby the underside of the skis and the front suspension assembly cannot be damaged by hard surfaces, such as asphalt roads, rocks, boulders and the like.

### SUMMARY OF THE INVENTION

The concept of the present invention is to provide an improved snow vehicle ski whereby the underside of the snow vehicle ski, and the front suspension assembly relating to the ski, cannot be damaged by a hard surface, including rocks, boulders, asphalt roads and the like. Contact with rocks is unpredictable and contact with asphalt roads is inevitable because many snow vehicle trails, at some point, may require the traversing of a road, and maybe even traversing several times when traveling along such trails.

The typical snow vehicle uses wear bars disposed on the underside of the skis. The primary feature of the improved snow vehicle ski of the present invention is the replacement of such wear bars with two in-line wheels disposed within the snow ski. The wheels aid in the snow ski's ability to roll over hard objects such as rocks that are often hidden under the snow and over hard surfaces such as asphalt, for example, which reduces the chance of damage to the snow ski or the elements of its associated front suspension assembly. The wheels of the ski also aid in the movement of the snow vehicle over surfaces such as hard packed snow and ice. In essence, the wheels are replacing the present wear bars to prevent wear to the bottom of the snow ski. The wheels are also useful when loading the snow vehicle onto, or unloading it from, a trailer. Further, the wheels provide the user with an enhanced turning force by extending the wheels slightly below a wheel support member that is disposed below the ski. The rather sharp wheel edges provide enhanced performance for the user by allowing the wheels to “dig into” the snow during usage.

In the improved snow vehicle ski of the present invention, wheel placement is novel and also distinguishes the ski from the prior art. More particularly, a rear wheel is disposed relatively close to a spindle pivot point, allowing the snow ski to rotate around the spindle pivot point with less steering effort and still providing for proper weight distribution and ski balance. Placement of a front wheel is important as the front wheel is the first wheel to encounter obstacles and needs to protect the rest of the ski and its associated suspension assembly parts by absorbing impact and shock to such parts. The front wheel location is also important for proper weight distribution, handling and steering of the machine. The front wheel further acts as a lever, as it helps turn the snow ski around the spindle pivot point, providing for less steering effort by the user. Further, the wheels can have a rubber surface or a hard and sharp surface. The wheels can also combine a hard inner core surrounded by a deformable and shock-absorbing rubber surface.

The foregoing and other features of the wheeled snow vehicle ski of the present invention will be apparent from the detailed description that follows.

### BRIEF DESCRIPTION OF THE DRAWINGS

FIG. 1 is a right side elevational view of a representative snow vehicle, here a snowmobile, showing its essential elements.

FIG. 2 is an enlarged side elevational view of the snow vehicle ski shown in FIG. 1 and showing the essential features relative to the present invention.

FIG. 3 is a further enlarged top plan view of the ski shown in FIG. 2 and taken along line 3-3 of FIG. 2.

FIG. 4 is another further enlarged side elevational and partially sectioned view of the ski shown in FIGS. 2 and 3 and taken along line 4-4 of FIG. 3.

### DETAILED DESCRIPTION OF THE INVENTION

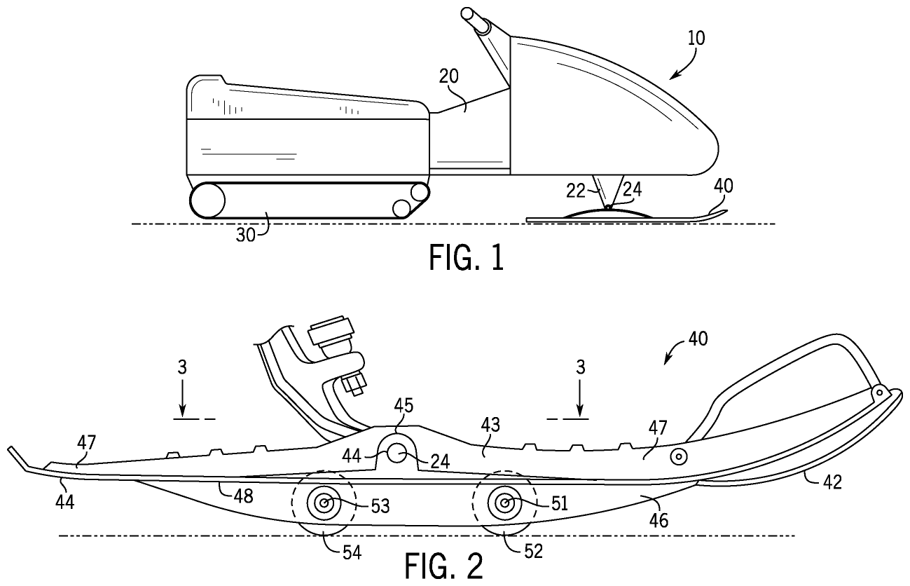

Referring now to the drawings in detail, wherein like-numbered elements refer to like elements throughout, FIG. 1 illustrates a right side view of a generic snowmobile, generally identified 10. The “right” and “left” sides are defined with reference to the forward travel direction of the snowmobile from the user's point of view. The snowmobile 10 comprises the essential elements of a body 20, a track 30 that is rearwardly and downwardly disposed relative to the body 20 (together with a rear suspension assembly), and a pair of snow skis 40 (one of which is shown in this illustration), the skis 40 being forwardly and downwardly disposed relative to the body 20, also shown with a generic front suspension assembly, generally identified 22. FIGS. 2 and 4 are likewise right side views of a ski 40 configured in accordance with the present invention. The skis 40 are attached to the body 20 via the front suspension assembly 22. Skis 40 configured in accordance with the present invention can be used with telescopic suspensions of the type used with snow bikes. In the case of snowmobiles, two types of front suspension assemblies are well known in the art. The first is typically referred to as a “trailing arm” suspension and the second is known as an “A-arm” suspension. Both systems (collectively, the “suspension assembly”) are relatively complex in construction and essential in use because they provide control and steering for the snowmobile user as well as cushioning for the user over rough terrain. Each ski 40 is connected to a spindle 24, the spindle 24 also being considered the “spindle pivot point” which is part of the overall front suspension assembly and steering assembly of the snowmobile 10. That is, the spindle 24 is operatively connected to the suspension assembly 22 via steering rods (not shown) which are part of the overall steering assembly (also not shown) that allows the user to steer the snowmobile 10 via the skis 40. Any damage to the front suspension assembly or the steering assembly impairs the intended operability of the snowmobile 10. Such damage prone to occur particularly during “mountain riding” use of the snowmobile 10—which is a form of riding over very rough and unpredictable terrains insofar as rocks and boulders may be partially or completely snow covered when encountered. Lastly, it will be appreciated that the ski or skis 40 referred to in this detailed description could be of the type used with a snow vehicle that is also referred to as a snow bike.

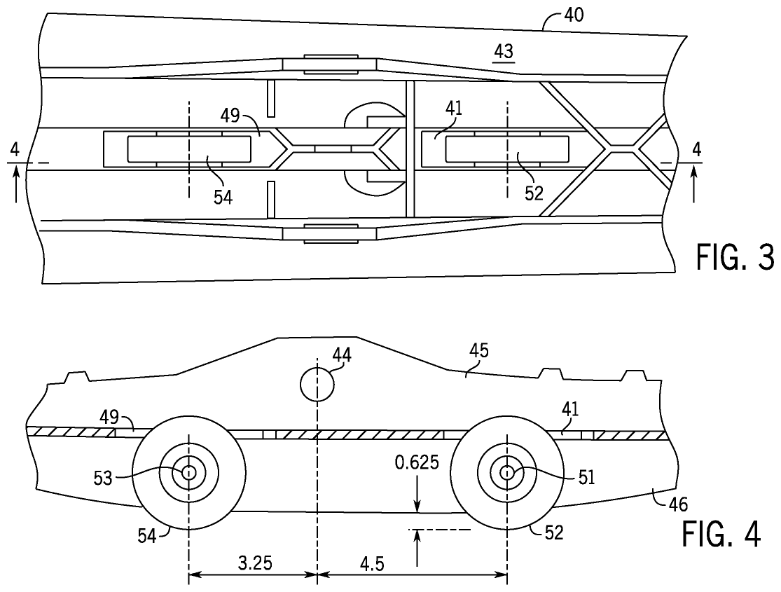

FIG. 2 is an enlarged side elevation view of the ski 40 shown in FIG. 1. The ski 40 comprises a forward or leading end portion 42, a medial portion 43 and a trailing end portion 44. The leading end portion 42 comprises an upwardly curved portion and this is the end that contacts snow as the snowmobile 10 is propelled forwardly. The ski 40 also comprises a top surface 47 and a bottom surface 48. Extending upwardly from the top surface 47 of the ski 40 and disposed at the medial portion 43 is a spindle support 45 that comprises a spindle hole 44. This allows the ski 40 to rotate slightly upwardly or downwardly about the spindle pivot point 24 depending on the grade of surface that the snowmobile 10 is travelling over. Extending downwardly from the bottom surface 48 is a wheel support member 46. The snow vehicle ski 40 that is made in accordance with the present invention eliminates the conventional carbide runner and wear bars. Secured generally within the medial portion 43 of the ski 40 is a pair of in-line wheels 52, 54. More specifically, there is a first (forwardmost) wheel 52 that is disposed between the leading (or forward) ski portion 42 and the medial portion 43. The second (rearwardmost) wheel 54 is disposed between the medial ski portion 43 and the trailing (or rearward) ski portion 44. The wheels 52, 54 can comprise a hard structure that is highly resistant to damage from impacts of the wheels 52, 54 with rocks, boulders, asphalt roads or other potentially damaging structures or surfaces. The hard structure can be a high durometer rubber such as a Shore D durometer that is used for harder materials including hard rubbers, semi-rigid plastics and hard plastics. A Shore D durometer rubber in excess of 80 is preferable, although other durometers could be used for the same purpose. The wheels 52, 54 can also comprise a hard inner core surrounded by a deformable and shock-absorbing outer rubber surface. In either case, the wheels 52, 54 can also comprise rather sharp wheel edges which provide enhanced performance for the user by allowing the wheels to “dig into” the snow and increase the turning force of the ski 40 during usage. See FIG. 3 in this regard.

Continuing with FIG. 3, it shows a top plan view of the medial portion 43 of the ski 40. It illustrates the front wheel 52 which is rotatably mounted within an opening 41 that is defined within the ski 40. It also illustrates the rear wheel 54 which is rotatably mounted within an opening 49 that is also defined within the ski 40. In this configuration, the front and rear wheels 52, 54, respectively, are longitudinally “in-line” with one another. As shown in FIG. 3, the wheel openings 41, 49, respectively, are likewise longitudinally in-line with one another. Further, each wheel 52, 54 has an outer diameter that allows it to fit within an opening 41, 49, respectively. FIG. 4 is a cross-sectioned view of the medial portion 43 of the ski 40 illustrated in FIG. 3.

As referenced at the outset, the rear wheel 54 is disposed relatively close to the spindle pivot point 24, allowing the ski 40 to rotate around the spindle pivot point 24 with less steering effort and still providing for proper weight distribution and ski balance. Placement of the front wheel 52 is important as the front wheel 52 encounters obstacles first and needs to protect the rest of the ski 40 and associated suspension parts. The front wheel location is also important for proper weight distribution, handling and steering of the snowmobile 10. The front wheel 52 acts as a lever, as it helps turn the ski 40 around the spindle pivot point 24, providing for less steering effort by the user.

FIG. 4 illustrates the dimensions that this inventor has found to be optimal for accomplishing the performance stated above. While specific dimensions are provided, this inventor notes, generally, that the distance between a vertical line drawn downwardly from the central axis of the spindle 24 provides a reference point for setting the distances from similar vertical lines drawn downwardly from the central axis 51 of the front wheel 52 and from the central axis 53 of the rear wheel 54. In all embodiments of the present invention, the distance between the central axis line 51 of the front wheel 52 and the vertical line of the spindle 24 is greater than the distance between the central axis line 53 of the rear wheel 54 and the vertical line of the spindle 24. In application, this relational guideline is essential to the performance of the snow vehicle ski 40 as intended by this inventor. It is to be understood that the dimensions shown in FIG. 4 are not limiting in any way.

The criticality and novelty of the present invention rests on the fact that the distance between the axis 51 of the front wheel 52 and the vertical line of the spindle 24 (the “first distance”) is greater than the distance between the axis 53 of the rear wheel 54 and the vertical line of the spindle 24 (the “second distance”). In the experience of this inventor, and if the first distance is equal to the second distance, the front skis 40 resist turning. Making the first distance greater than the second distance enhances the user's ability to turn the front skis 40. Placing the front wheel 52 more forwardly enhances performance, as long as the first distance is greater than the second distance as described above.

FIGS. 2 and 4 show a similar optimal performance distance between the bottom of the wheels 52, 54 and the wear bar or stabilizer 46. This results in the wheels 52, 54 engaging any hard surface to protect a leading end portion 42 and the trailing end portion 44 of the ski 40, respectively.

In view of the foregoing, it will be apparent that the present invention provides a unique and novel solution for protecting the bottom 48 of the ski 40 of a snowmobile 10 as well as the front suspension assembly related thereto, and for any type of known snow vehicle with which the snow ski 40 is or can be used.

In view of the foregoing, I claim the following:

1. A snow vehicle ski comprising:
a leading end portion;
a medial portion;
a trailing end portion;
a top surface;
a bottom surface;
a spindle support extending upwardly from the top surface of the ski and disposed at the medial portion of the ski;
a spindle pivot point;
a first wheel opening disposed in the ski between the leading end portion and the medial portion;
a second wheel opening disposed in the ski between the medial portion and the trailing end portion;
wherein the first wheel opening and the second wheel opening are disposed longitudinally and in-line relative to the ski;
a front wheel rotatably and fixedly mounted within the first wheel opening, the front wheel having an outer diameter;
a rear wheel rotatably and fixedly mounted within the second wheel opening, the rear wheel having an outer diameter;
wherein the front wheel and the rear wheel are disposed longitudinally in-line relative to the ski;
wherein each one of the wheels is fixedly mounted vertically such that a portion of each wheel extends below the bottom surface of the ski;
wherein the front wheel is fixedly disposed forwardly of the spindle pivot point;
wherein the rear wheel is fixedly disposed rearwardly of the spindle pivot point; and
wherein the wheels are in contact with a surface below the ski at all times during use of the snow vehicle.

2. The snow vehicle ski of claim 1 wherein the forwardly disposed front wheel comprises an axis and the rearwardly disposed rear wheel comprises an axis; wherein a vertical line drawn downwardly from the central axis of the spindle provides a reference point for setting the distances from the vertical lines drawn downwardly from the central axis of the front wheel and from the central axis of the rear wheel; and wherein the distance between the central axis line of the front wheel and the central axis of the vertical line of the spindle is greater than the distance between the central axis line of the rear wheel and the central axis of the vertical line of the spindle.

3. The snow vehicle ski of claim 2 wherein each of the wheels comprises a hard structure that is highly resistant to impact damage.

4. The snow vehicle ski of claim 3 wherein each of the wheels comprises a Shore D durometer rubber of 80 or greater.

5. The snow vehicle ski of claim 2 wherein each of the wheels comprises a hard inner core surrounded by a deformable and shock-absorbing rubber surface.

6. The snow vehicle ski of claim 2 wherein each of the wheels comprise sharp wheel edges.

7. A snow vehicle assembly comprising a body and a pair of skis in accordance with claim 1.

8. A snow vehicle assembly comprising a body and a single ski in accordance with claim 1.
